(19) United States
(12) Patent Application Publication
(10) Pub. No.: US 2014/0117721 A1
(43) Pub. Date: May 1, 2014

(54) MODULAR AUTOMOTIVE ASSEMBLY WITH INTERCHANGEABLE INSERT

(71) Applicant: Ring Brothers, Spring Green, WI (US)

(72) Inventors: Michael D. Ring, Plain, WI (US); James A. Ring, Spring Green, WI (US)

(73) Assignee: Ring Brothers, Spring Green, WI (US)

(21) Appl. No.: 14/056,405

(22) Filed: Oct. 17, 2013

Related U.S. Application Data
(60) Provisional application No. 61/718,921, filed on Oct. 26, 2012.

(51) Int. Cl. B62D 25/10

(52) U.S. Cl. CPC B62D 25/105
USPC 296/193.11

(57) ABSTRACT

The present technology provides a modular hood assembly for a vehicle. The modular hood assembly comprises a hood base installed on the vehicle. The hood base can have an opening exposing at least a portion of the engine of the vehicle. The hood base can also include a base connector surface around at least a portion of the opening. The modular hood assembly also comprises an interchangeable hood insert removably attachable to the hood base. The interchangeable hood insert can include a base connector surface adapted to connect with the insert connector surface of the hood base. The interchangeable hood insert covers at least a portion of the opening when attached to the hood base. The modular hood assembly can also include at least one connector that attaches the interchangeable hood insert to the hood base.

### RELATED APPLICATIONS

This application makes reference and claims priority to U.S. Provisional Patent Application No. 61/718,921, filed Oct. 26, 2012, by Michael D. Ring et al, titled “Modular Automotive Assembly With Interchangeable Insert.” U.S. Provisional Patent Application No. 61/718,921 is hereby incorporated by reference in its entirety.

### BACKGROUND

Exterior automobile components are typically designed to be permanent fixtures that are not easily replaceable by the owner. For example, the original hood of an automobile will typically remain the one and only hood for the life of the vehicle absent significant physical damage. In the event that the hood does need to be replaced, such replacement usually requires the equipment and experience possessed only by professional mechanics. Such replacement is time consuming and expensive, and thus serves as a deterrent from frequent interchanging of the exterior components of an automobile or vehicle.

### SUMMARY

The present technology generally relates to components for installation onto a vehicle, for example, an automobile. More specifically, the present technology provides for the installation of interchangeable components and/or inserts on a vehicle. For example, the present technology provides systems and methods that allow for a variety of hood designs to be readily installed, replaced, and interchanged on a vehicle.

Certain aspects of the present technology provide a modular hood assembly for a vehicle. The modular hood assembly comprises a hood base installed on the vehicle. The hood base can have an opening. For example, the opening can expose at least a portion of the engine of the vehicle. The hood base can also include a base connector surface around at least a portion of the opening. In some embodiments, the modular hood assembly also comprises an interchangeable hood insert removably attachable to the hood base. The interchangeable hood insert can include a base connector surface that is adapted to connect with the insert connector surface of the hood base, for example. In this manner, the hood insert can be removably attached to the hood base. In some aspects, the interchangeable hood insert covers at least a portion of the opening when attached to the hood base. The modular hood assembly can also include at least one connector that attaches the interchangeable hood insert to the hood base. For example, the base connector surface and the insert connector surface can comprise a plurality of holes, wherein the holes of the base connector surface are configured to align with the holes of the insert connector surface. In this manner, the modular hood assembly can also include a connector that is a bolt and/or a screw that can be placed through the holes of the hood base and hood insert and tightened to attach the hood insert to the hood base. The modular hood assembly can also comprise one or more locking mechanisms that secure the interchangeable hood insert to the hood base. In some aspects, the modular hood assembly includes a plurality of interchangeable hood inserts, each hood insert being removably attachable to the hood base in a manner to cover the opening of the hood base.

Further embodiments of the present technology relate to a modular hood component for installation on a vehicle. In some aspects, the modular hood component can be, or can comprise a hood base configured to be installed on the vehicle. The hood base can have an opening and a base connector surface around at least a portion of the opening. For example, the base connector surface can surround all or a portion of the opening. The hood base can be configured to be removably attached or attachable to one or more interchangeable hood inserts. In this manner, the interchangeable hood inserts can be installed onto the hood base and cover all, or at least a portion of the opening of the base component. In some embodiments, the base connector surface comprises a plurality of holes, wherein the holes of the base connector surface are configured to align with holes on one or more interchangeable hood inserts.

Additional aspects of the present technology relate to an interchangeable component for use with a modular hood assembly installed on a vehicle. In some aspects, the interchangeable component can be, or can comprise a hood insert having an insert connector surface. The hood insert can be configured to removably attach to a hood base installed on the vehicle, for example, a hood base having an opening that exposes at least a portion of the engine of the vehicle. The hood insert can be configured to be removably attached or attachable to the hood base, and configured to cover all or at least a portion of the opening when attached to the hood base. In some embodiments, the insert connector surface comprises a plurality of holes, wherein the holes of the insert connector surface are configured to align with holes on the hood base.

### BRIEF DESCRIPTION OF THE DRAWINGS

FIG. 1 shows vehicle with a hood base having an opening in accordance with one or more aspects of the present technology.

FIG. 2 shows a vehicle with a hood base and an interchangeable hood being installed onto the hood base.

FIG. 3 shows a vehicle with a hood base having a first interchangeable hood insert installed on the hood base.

FIG. 4 shows a vehicle having a second interchangeable hood insert installed on the hood base.

FIG. 5 shows a vehicle having a third interchangeable hood design installed on the hood base.

FIG. 6 provides a flow diagram for a method of installing one or more interchangeable hood inserts on a vehicle in connection with at least one embodiment of the present technology.

### DETAILED DESCRIPTION

Some vehicle owners desire to make improvements, additions, or changes to the appearance or functionality of their vehicles in a manner that may not be compatible with the original shape and design of the vehicle and its components. For example, an owner may desire to install a supercharger on the engine of a vehicle so that the engine is capable of generating more power. The owner may run into difficulty, however, if the original configuration of the hood of the vehicle is not adapted to provide the space and air intake that is necessary to accommodate such a supercharger. Moreover, some owners may desire to implement a temporary change in the visual appearance or look of a vehicle. For example, an owner may wish to employ a vehicle hood having a different shape, color, or design, or to utilize a different spoiler configuration on the rear of the vehicle, without having to entirely dispose of the vehicle's original components. Given the current state of the art, it is not practical for vehicle owners to employ the use of temporary components on their vehicles because the installation process is too complicated, expensive and time consuming.

The present technology generally relates to components for installation onto a vehicle and methods for installing the components. More specifically, the present technology relates to a system that allows a user to easily replace vehicle components to employ different vehicle configurations on a day-to-day basis, if desired. For example, the present technology provides systems and methods that allow a user to quickly and easily (i.e., without the need for a professional auto mechanic or expensive machinery and tools) install a different hood and/or trunk configurations on a vehicle or automobile in order to accommodate additional vehicle modifications or to employ a different vehicle appearance.

In some embodiments, the present technology provides a modular automotive hood assembly having one or more interchangeable hood inserts. The hood can include, for example, a hood base that can be installed onto a vehicle in a similar manner as standard hood. In some embodiments, the hood base has an opening or a hole that exposes at least a portion of the engine of the hood. In some embodiments, the opening can expose whatever contents reside beneath the hood. For example, the opening can expose the engine of the vehicle. In some embodiments, the hood can be a component on the rear of a vehicle, and the opening can expose the trunk, or other components on the rear of the vehicle.

In some embodiments, a connector surface surrounds the opening of the hood. The connector surface can be configured to mate, attach, and/or connect with an interchangeable hood insert. For example, an hood insert can be attached to the hood by attaching the hood insert to the hood base such that the hood insert resides above, within, or on the opening. In some embodiments, the hood insert has a connector surface that is configured for attaching the hood insert to the hood base. The hood insert can have a connector surface that is adapted to mate, connect, and/or attach with the connector surface of the hood opening. For example, the hood base connector surface can have one or more of tabs, grooves, holes, clips, magnets, or other connecting mechanisms that are adapted to mate with corresponding tabs, grooves, holes, clips, magnets, or other connecting mechanisms on the connector surface of the hood insert.

In some embodiments, the connector surfaces of the hood base and hood insert have holes that are adapted to receive bolts or screws. In this manner, the hood insert can be placed over the opening of the hood so that the holes of the connector surface surrounding the hood opening align with the holes of the mating surface of the hood insert. A user can then quickly and easily attach the hood insert to the hood by screwing and/or bolting the hood insert to the hood through the holes, for example.

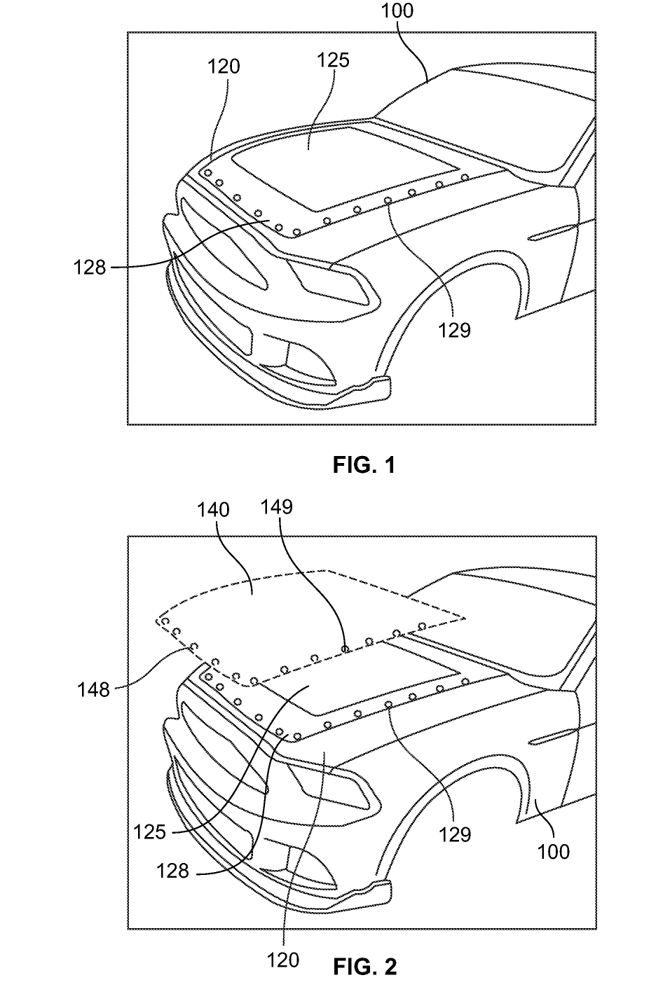

FIGS. 1-5 provide further detail of the modular hood assembly of the present technology. FIG. 1 shows a vehicle 100, having a hood structure, or hood base 120 installed. As shown in FIG. 1, the hood base 120 has an opening 125 that, in some embodiments, can expose at least a portion of the engine of the vehicle. The hood base 120 can be made out of a variety of materials, including but not limited to plastic, fiberglass, carbon fiber, steel or other metals, or a combination thereof.

In some embodiments, hood base 120 can be installed on to any vehicle or automobile in place of the original hood of the vehicle. In some embodiments, hood base 120 can be a trunk base, for example, on the rear of the vehicle. In this manner, the opening 125 can expose the contents of the trunk of the car, for example.

The hood base 120 has a base connector surface 128. The base connector surface 128 can be adapted to connect with a corresponding connecting surface on a hood insert. For example, the base connector surface 128 of the hood base can comprise one or more holes 129 that are configured to align with one or more holes on a corresponding connecting surface of a hood insert. In some embodiments, the connector surface 128 of the hood base 120 can comprise one or more of magnets, hooks, clips, snaps, fastener, tape, adhesive or a glue, that is adapted to facilitate attachment of a hood insert to the hood base 120.

An owner or user of vehicle 100 can, for example, purchase, borrow, or otherwise obtain the hood base 120 and install the hood base 120 on the vehicle 100, replacing the original hood of the vehicle. In some embodiments, the original hood of the vehicle 100 can be converted to the hood base 120, for example, by creating an opening in the original hood of the vehicle 100. With the hood base 120 in place, the user or owner can also purchase, borrow, or otherwise obtain a variety of interchangeable hood inserts for use in connection with the hood base 120.

FIG. 2 depicts a modular hood assembly of the present technology with an interchangeable hood insert 140 as it is applied to the hood base 120. In this manner the user can change the look and cosmetic appearance of the hood of the vehicle 100. The hood insert 140 comprises an insert connector surface 148, or a connector border that provides for the attachment of the hood insert 140 to the hood base 120. For example, the insert connector surface 148 can be connected to the base connector surface 128. The insert connector surface 148 can comprise, for example, one or more connectors or connector mechanisms to facilitate attachment to the hood base 120. For example, as shown in FIG. 2, the insert connector surface 148 comprises a plurality of holes 149. The holes 149 can be configured to align with the holes 129 on the base connector surface 128 of the hood base 120. In this manner, a hood insert 140 can be attached to a hood base 120 by placing the hood insert 120 on the hood base 140 such that the holes 149 on the insert connector surface 148 align with the holes 129 on the base connector surface 128. The user can then easily attach the hood insert 140 to the hood base 120 by inserting screws, bolts, pins, or other connecting devices through the holes 129/149.

The connector surfaces 128/148 of the hood base 120 and the hood insert 140 can employ a variety of mechanisms and/or methods for attaching the hood insert 140 to the hood base 120. In some embodiments, for example, the hood base 120 and/or the hood insert 140 can comprise one or more connectors that can be used to facilitate the attachment. For example, the present technology can employ connectors such as a fastener, a clip, a pin, a button, a snap connector, a belt, a tie strap, a magnet, a hook, a bolt, a screw, a nail, a staple, an adhesive or glue. In some embodiments, for example, where the connector surfaces 128/148 comprise one or more holes, the connector can be a bolt, screw, pin, rod, peg, or dowel. In some embodiments, the hood base connector surface 128 can comprise a series of slots adapted to receive a series of tabs located on the insert connector surface 148. Additionally and/or alternatively, the series of slots on the insert connector surface 148 can be adapted to receive another connector such as a belt, a tie-strap, a rope, or a cord, for example.

The connector surfaces 128/148 of the hood base 120 and hood insert 140 can also include magnets, hooks, clips, snaps, fastener, tape, adhesive or a glue as a part of the hood base 120 and/or the hood insert 140 as connectors to provide for the attachment of the two components. In further embodiments, the hood base connector surface 128 and the hood insert connector surface 148 can be flat or parallel surfaces adapted to align and lie flush with one another so that user can staple, nail, screw, weld, glue or otherwise attach the hood insert to the hood base. In some aspects, the base connector surface 128 can include a male or female mating part that corresponds with a corresponding female or male mating part on the insert connector surface 148. The corresponding male and female components can provide for a snap-fit, a friction fit, or an otherwise secure connection, for example.

In some embodiments, the connector surfaces 128/148 of the hood base and hood insert can also comprise alignment mechanisms that assist a user in aligning the hood base with the hood insert before attachment. For example, the hood base connector surface 128 can comprise a series of markings such as numbers, arrows, notches, gooves, or other identifiers that correspond with similar markings on the insert connector surface 148. In this manner, the corresponding markings can be aligned so that a user knows that the hood insert 140 is in a proper position for installation onto the hood base 120.

In some embodiments, the modular hood assembly of the present technology can also include a locking mechanism, such as a lever, that allows for the hood insert to be placed on the hood base and locked into place. For example, when the user desires to remove and/or replace the hood insert 140, the user can place the hood insert 140 onto the hood base 120 at the proper location, and operate the locking mechanism to attach and secure the hood insert 140 to the hood base 120. The locking mechanism can be, but is not limited to a lever, a button, a twist-lock, or a pull-cord, for example. The locking mechanism can be located on the hood base 120, on the hood insert 140 or on another location of the vehicle. For example, the locking mechanism can be in a position such that a user can activate the locking mechanism from the driver's seat of the vehicle 100. The locking mechanism can secure and attach the hood insert 140 to the hood base 120 via a variety of methods, using a variety of attaching devices. For example, the locking mechanism can activate a magnetic connection. Additionally, the locking mechanism can activate a mechanical connection, for example, by moving a hook, arm, lock, clamp, or lever on the hood base 120 into a corresponding slot, hole, tab, tongue, groove, or other mating component on the hood insert 140.

Using some embodiments of the present technology, a user can obtain multiple interchangeable hood inserts 140 that provide different functions, or have different looks, and swap out the various inserts 140 with the hood base 120 at the user's choosing. Each interchangeable hood insert 140 can have a different shape, color, pattern, design or functional utility. For example, certain interchangeable hood inserts 140 may be designed to improve the air intake and circulation in the engine area. Certain hood inserts may be designed to accommodate additional engine components such as a supercharger, for example. And some hood inserts can be designed to reduce drag and improve aerodynamics of the vehicle. In still further embodiments, the hood insert 140 can be transparent or translucent such that the engine of the vehicle 100 can be viewed even when the hood insert 140 has been installed. As with the hood base 120, the hood insert can be made out of a variety of materials, including but not limited to fiberglass, plastic, carbon fiber, steel or other metals, or a combination thereof.

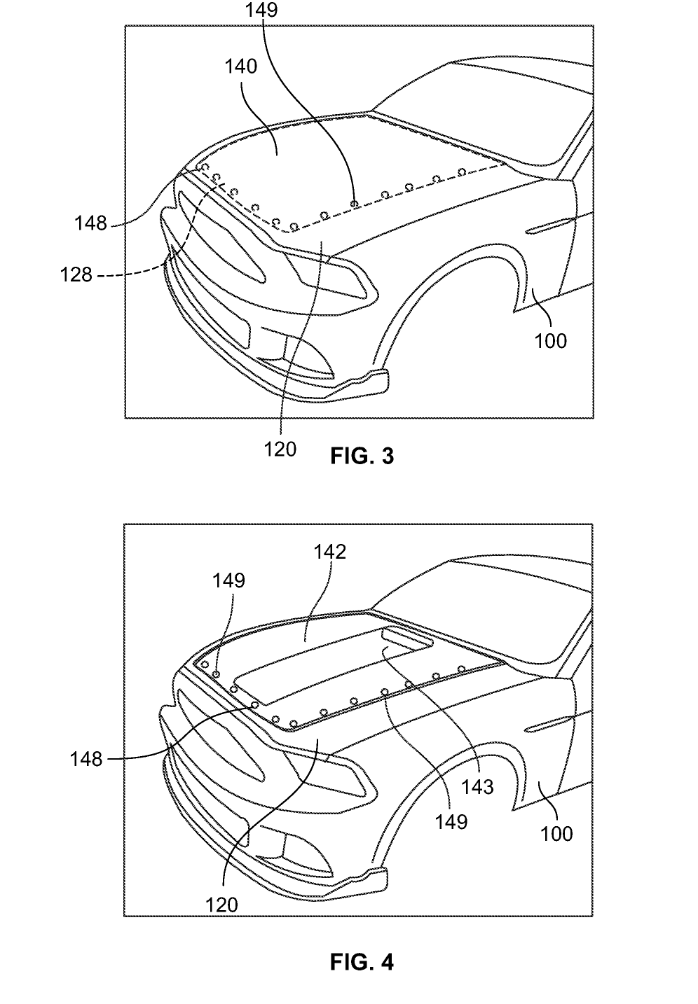

FIG. 3 depicts the modular hood assembly of the present technology with the interchangeable hood insert 140 installed onto the hood base 120. The hood insert 140 can be installed by a number of methods, using a variety of equipment, as described above. For example, the hood insert 140 can be attached using a fastener, a clip, a pin, a button, a snap connector, a belt, a tie strap, a magnet, a hook, a bolt, a screw, a nail, a staple, an adhesive or glue. The hood insert 140 can be welded onto the hood base 120, or attached via a snap-fit or direct connection method. Additionally, the hood insert 140 can be placed onto the hood base 120 and then locked and/or secured into place with a locking mechanism. As shown in FIG. 3, the hood insert 140 has been placed on the hood base 120 over the opening 125 such that the connector surface 148 of the hood insert 148 aligns with the connector surface 128 of the hood base 120. In this manner, holes 149 on the hood insert 140 align with holes 129 on the hood base 120 so that screws, bolts, pins, and/or pegs, for example, can be inserted through the holes and tightened to secure the hood insert 140 in place with respect to the hood base 120.

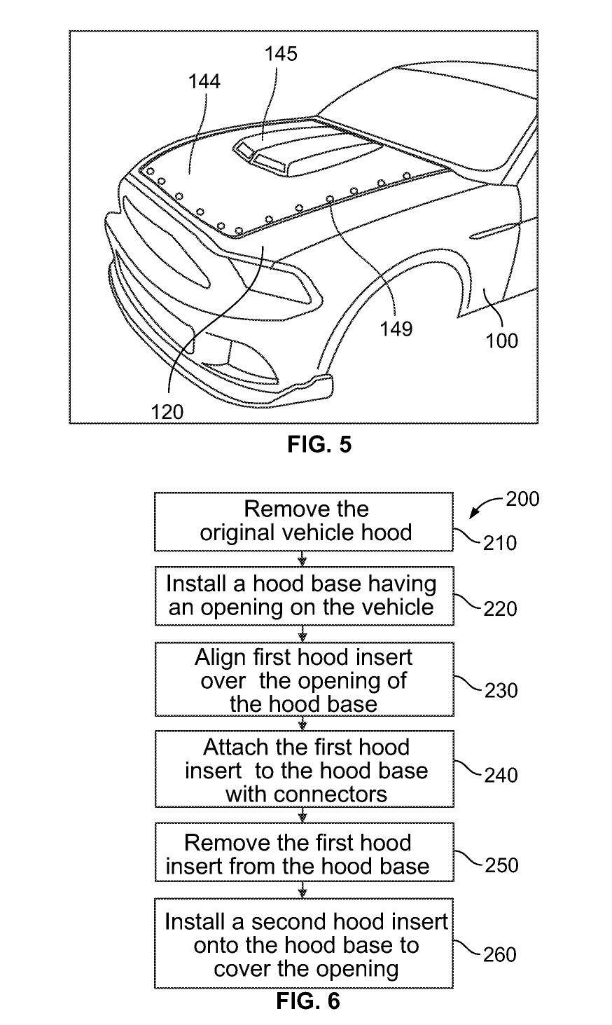

FIGS. 4 and 5 depict modular hood assemblies of the present technology employing a variety of interchangeable hood inserts that have different designs, visual appearances, and/or functionality. For example, FIG. 4 depicts a hood insert design 142 that provides a recessed portion 143. The recessed portion 143 can offer a visual appearance that may provide aesthetic value, and it can also provide functionality. For example, the recessed portion 143 can provide for the engine to intake air.

FIG. 5 depicts a hood insert design 144 that has a raised portion 145. The raised portion 145 can also provide an aesthetic benefit as well as functionality. For example, the raised portion 145 can provide more space under the hood assembly, thereby making room for larger engine equipment, such as a supercharger, for example. The hood inserts can come in a variety of other designs, and can also include functional features, such as an opening that allows for air intake into the engine area of the vehicle, for example.

The hood insert 140 of the present technology can be provided a different color from that of the hood base 120 to provide a certain look and feel to the vehicle 100. Additionally and/or alternatively, the hood insert 140 can also be a similar or identical color to that of the hood base 120, and/or to the rest of the vehicle 100. For example, in certain embodiments, the hood insert 140 may be of a color and configuration that disguises the fact that the hood insert 140 is interchangeable. This can be accomplished, for example, by making the hood insert 140 the same color as the hood base 120, and employing a connection method that makes the connection method undetectable, or difficult to detect by eye from the exterior of the vehicle.

The present technology also provides methods for modifying the hood of a vehicle. FIG. 6 provides a flow diagram for a method 200 of installing one or more interchangeable hood inserts on a vehicle in connection with at least one embodiment of the present technology. At step 210 the original hood is removed from the vehicle. Typically, the original hood will not be adapted to receive the interchangeable hood inserts of the present technology. Accordingly, the original hood can be removed to make way for a hood base of the present technology.

At step 220, a hood base of the present technology is installed in the place of the original hood. The hood base can have an opening adapted to receive one or more hood inserts. In some embodiments, the hood opening exposes at least a portion of the engine of the vehicle. The hood base can also comprise a connector surface, which can include, for example, holes and/or connectors.

At step 230, an interchangeable hood insert of the present technology is aligned over the opening of the hood base. The interchangeable hood insert can also comprise a connector surface, which can include, for example, holes and/or connectors. In some embodiments, the hood insert is aligned over the hood base so that the connector surfaces of the hood base and the hood insert are aligned. For example, in some embodiments, at step 230, the hood insert is placed over the opening of the hood base, and the holes on the connector surface of the hood insert are aligned with corresponding holes on the connector surface of the hood base.

At step 240, the first hood insert is attached to the hood base using connectors. For example, in some embodiments, screws, bolts, and/or pins are placed through the holes of the hood base and the hood insert and tightened to secure the hood insert on the hood base of the vehicle. In some embodiments, other connectors are used to secure the hood insert to the hood base. For example, the hood insert can be attached using a fastener, a clip, a pin, a button, a snap connector, a belt, a tie strap, a magnet, a hook, a bolt, a screw, a nail, a staple, an adhesive or glue. In some embodiments, the hood insert 140 can be welded onto the hood base 120, or attached via a snap-fit or direct connection method. The hood insert can also be secured using corresponding mating parts on the hood insert and/or the hood base. For example, in some embodiments, tabs on the hood insert can be inserted into slots on the hood base to secure the hood insert in place. Additionally and/or alternatively, the hood insert can be placed onto the hood base and then locked and/or secured into place with a locking mechanism.

At step 250, the first hood insert is removed from the hood base. For example, the connectors can all be removed and/or manipulated to release the hood insert from the hood base. Where the hood insert was attached to the hood base using screws, bolts, and/or pins placed through holes in the first hood insert and the hood base, the screws, bolts, and/or pins can be removed, and the first hood insert can thus be lifted off of the hood base. In this manner, when a user desires to change out the first hood insert with another, the user can simply remove, or uninstall the first hood insert to make way for a second hood insert to be installed.

At step 260, a second hood insert is installed in place on the hood base. The second hood insert can be installed on the hood base in the same manner as the first hood insert was installed, for example. The second hood insert can be of a different design than the first hood insert. For example, the second hood insert can have a different color, shape, pattern, and/or functionality from that of the first hood insert. A user can remove the second hood insert and replace it with the first hood insert, or with another hood insert as desired.

The description of the present technology has been provided herein as relating primarily to the hoods of a vehicle or automobile. However, the technology is not intended to be limited exclusively to vehicle hoods. For example, the present technology can be applied to any component of a vehicle, automobile, or any motor vehicle. For example, the present technology can be used to provide interchangeable components on the rear of a vehicle, such as at the trunk, or in the bed of a truck. The present technology can also be used to allow a user to interchangeably replace the spoiler design on the rear of a vehicle. The present technology can also be applied other vehicle components such as minor caps, fenders, front grills, doors, rooftops or windshields. Accordingly, it should be recognized that any reference herein to a vehicle hood, hood base, or hood insert can be considered a reference to another vehicle component, such as a trunk (trunk base or trunk insert) or a truck bed (truck bed base or truck bed insert), for example, with any modifications made as necessary (and as would be appreciated by a person of ordinary skill in the art) to accommodate the utility, functionality, and/or operation of the particular vehicle component.

The present technology provides unexpected and surprising results that allow a user to interchangeably replace components, such as a hood, on an vehicle. The present technology provides systems and methods that allow for a quick and easy installation of components at home, in a garage or in a driveway without the need for expensive equipment, or the assistance of a professional mechanic. The present technology thereby allows a user to change the appearance and/or function of a vehicle on a regular basis without the need to expend significant time and resources.

The present technology has now been described in such full, clear, concise and exact terms as to enable any person skilled in the art to which it pertains, to practice the same. It is to be understood that the foregoing describes preferred embodiments and examples of the present technology and that modifications may be made therein without departing from the spirit or scope of the invention as set forth in the claims. Moreover, it is also understood that the embodiments shown in the drawings, if any, and as described above are merely for illustrative purposes and not intended to limit the scope of the invention. As used in this description, the singular forms “a,” “an,” and “the” include plural reference such as “more than one” unless the context clearly dictates otherwise. Further, all references cited herein are incorporated in their entirety.

1. A modular hood assembly for a vehicle comprising:
a hood base installed on the vehicle, the hood base having an opening; and
an interchangeable hood insert removably attachable to the hood base,
wherein the interchangeable hood insert covers at least a portion of the opening when attached to the hood base.

2. The modular hood assembly of claim 1, wherein the hood base further comprises a base connector surface around at least a portion of the opening,
wherein the interchangeable hood insert comprises an insert connector surface, and
wherein the base connector surface is adapted to connect with the insert connector surface to removably attach the interchangeable hood insert to the hood base.

3. The modular hood assembly of claim 2, further comprising at least one connector, wherein the at least one connector attaches the interchangeable hood insert to the hood base.

4. The modular hood assembly of claim 3, wherein the base connector surface and the insert connector surface comprise a plurality of holes, wherein one or more holes of the base connector surface are configured to align with one or more holes of the insert connector surface.

5. The modular hood assembly of claim 4, wherein the connector is at least one of a bolt or a screw, wherein the bolt or screw is adapted to be placed through a hole on the base connector surface and a hole on the insert connector surface to attach the interchangeable hood insert to the hood base.

6. The modular hood assembly of claim 3, wherein the connector is at least one of a fastener, a clip, a pin, a button, a snap connector, a belt, a tie strap, a magnet, a hook, a bolt, a rope, a string, a cord, a screw, a nail, a staple, tape, an adhesive or glue.

7. The modular hood assembly of claim 3, wherein the connector is built into the base connector surface, and wherein the connector is adapted to attach to a corresponding component that is built into the insert connector surface.

8. The modular hood assembly of claim 3, wherein the connector is built into the insert connector surface, and wherein the connector is adapted to attach to a corresponding component that is built into the base connector surface.

9. The modular hood assembly of claim 1, further comprising a locking mechanism that secures the interchangeable hood insert to the hood base.

10. The modular hood assembly of claim 1, wherein the hood base covers an engine of the vehicle, and wherein the opening of the hood base exposes at least a portion of the engine.

11. The modular hood assembly of claim 1, further comprising a second interchangeable hood insert removably attachable to the hood base, wherein the second interchangeable hood insert covers at least a portion of the opening when attached to the hood base.

12. The modular hood assembly of claim 1, wherein the hood assembly is configured to cover an engine of the vehicle, and
wherein the modular hood assembly is adapted to increase the air intake into the engine.

13. The modular hood assembly of claim 1, wherein the hood insert is configured to allow a supercharger to be installed in the vehicle beneath the modular hood assembly.

14. A modular hood component for installation on a vehicle, the component comprising:
a hood base configured to be installed on the vehicle, the hood base having an opening and a base connector surface around at least a portion of the opening,
wherein the hood base is configured to be removably attached to an interchangeable hood insert, and
wherein the interchangeable hood insert covers at least a portion of the opening when attached to the hood base.

15. The modular hood component of claim 14, wherein the hood base further comprises a plurality of holes on the base connector surface, wherein one or more of the plurality of holes are configured to align with one or more holes on the interchangeable hood insert.

16. The modular hood component of claim 15, wherein the hood base is adapted to be secured to the interchangeable hood insert by at least one of a bolt or a screw,
wherein the bolt or screw is adapted to be placed through a hole on the base connector surface and a hole on the interchangeable hood insert.

17. The modular hood component of claim 14, wherein the hood base is configured to be removably attached to a plurality of interchangeable hood inserts.

18. An interchangeable component for use with a modular hood assembly installed on a vehicle, the interchangeable component comprising:
a hood insert comprising an insert connector surface,
wherein the hood insert is configured to removably attach to a hood base installed on the vehicle, the hood base having an opening, and
wherein the interchangeable hood insert covers at least a portion of the opening when attached to the hood base.

19. The interchangeable component of claim 18, wherein the hood insert further comprises a plurality of holes on the insert connector surface, wherein one or more of the plurality of holes are configured to align with one or more holes on the hood base.

20. The interchangeable component of claim 19, wherein the hood insert adapted to be secured to the hood base by at least one of a bolt or a screw,
wherein the bolt or screw is adapted to be placed through a hole on the insert connector surface and a hole on the hood base.
